(19) United States
(12) Patent Application Publication
(10) Pub. No.: US 2002/0162901 A1
(43) Pub. Date: Nov. 7, 2002

(54) Rotor type sprinkler with turbine over-spin prevention

(76) Inventors: Richard E. Hunter, La Jolla, CA (US); William D. Holton, Vista, CA (US); Loren W. Scott, Carlsbad, CA (US)

Correspondence Address: ATTN: Michael H. Jester, THE LAW OFFICES OF MICHAEL H. JESTER, 750 B STREET, SUITE 2560, SYMPHONY TOWERS, SAN DIEGO, CA, 92101, US

(21) Appl. No.: 09/846,994

(22) Filed: May 1, 2001

(51) Int. Cl. B05B 3/04

(52) U.S. Cl. 239/240; 239/263.3

(57) ABSTRACT

A sprinkler includes a riser having a lower end for receiving a pressurized fluid and a nozzle that is mounted at an upper end of the riser for rotation about an axis. A turbine is mounted for rotation inside the riser. A drive mechanism connects the turbine to the nozzle so that rotation of the turbine by the pressurized fluid rotates the nozzle. The sprinkler includes mechanisms for preventing over-spinning of the turbine when the pressurized fluid is air or a mixture of air and water. Damage to the turbine drive shaft or its bearings due to over-spinning of the turbine is thereby avoided. In one version of the sprinkler, the over-spinning prevention mechanism applies a brake force to the turbine. In another version of the sprinkler, the over-spinning prevention mechanism re-directs air or a mixture of water and air around the turbine.

### FIELD OF THE INVENTION

The present invention relates to irrigation equipment, and more particularly, to sprinklers of the type that use internal turbines to rotate a nozzle to distribute water over turf or other landscaping.

### BACKGROUND OF THE INVENTION

Many regions of the world have inadequate rainfall to support lawns, gardens and other landscaping during dry periods. Sprinklers are commonly used to distribute water over such landscaping in commercial and residential environments. The water is supplied under pressure from municipal sources, wells and storage reservoirs. So called “hose end” sprinklers were at one time in widespread use. As the name implies, they are devices connected to the end of a garden hose for ejecting water in a spray pattern over a lawn or garden. Fixed spray head sprinklers which are connected to an underground network of pipes have come into widespread use for watering smaller areas. Impact drive sprinklers have also been used to water landscaping over larger areas starting decades ago. They are mounted to the top of a fixed vertical pipe or riser and have a spring biased arm that oscillates about a vertical axis as a result of one end intercepting a stream of water from a nozzle. The resultant torque causes the nozzle to gradually move over an adjustable arc and a reversing mechanism causes the nozzle to retrace the arc in a repetitive manner. Rotor type sprinklers have largely supplanted impact drive sprinklers, particularly on golf courses and playing fields, because they are quieter, more reliable and distribute a much more precise amount of precipitation more uniformly over a given sector size.

A rotor type sprinkler typically employs an extensible riser which pops up out of a fixed outer housing when water pressure is applied. The riser has a nozzle in a rotating head mounted at the upper end of the riser. The riser incorporates a turbine which drives the rotating head via a gear train reduction, reversing mechanism and arc adjustment mechanism. The turbine is typically located in the lower part of the riser and rotates about a vertical axis at relatively high spend.

Golf courses typically utilize so called “valve-in-head” rotors which operate under relatively high water pressures, e.g. seventy PSI and higher. They incorporate ON/OFF diaphragm valves in their lower ends that can be opened and closed under electrical or pneumatic control. In regions that experience freezing conditions in the Winter, it is necessary to winterize a sprinkler system. This involves removing all of the water in the system to prevent breakages otherwise due to the expansion of water as it freezes. A common way of removing the water is to pressurize the supply lines that lead to the various rotors with air. This can last as long as two to eight hours. This causes the turbines to spin at rotational rates which are too high, often damaging the turbine bearings and/or turbine shaft. The rotor normally moves one complete resolution in about three minutes. With only purging air flowing through the rotor, this cycle time can be reduced to fifteen seconds. The water in a rotor typically functions as a lubricating medium for the turbine drive shaft, and its absence can lead to melted plastic bearings. Grit next to an over-spinning turbine drive shaft can eventually sever the shaft. When such irrigation systems are re-activated in the Spring, the supply lines are refilled with high pressure water. This pushes out any air in the system through the rotors, once again subjecting their turbines and related nozzle drive components to potential damage. Surge conditions resulting from a mixture of high pressure water and air can also damage the turbine bearings and related nozzle drive components of a rotor type sprinkler.

U.S. Pat. No. 4,815,662 of Edwin J. Hunter discloses a rotary stream sprinkler in which a stream of water strikes an inverted, vaned conical distributor head. A damping device is connected to the distributor head for controlling the rotational velocity thereof. The damping device includes a rotor inside and oil-filled stator housing. This design places a constant drag on the rotation of the distributor head and is incapable of selectively applying the drag only if the fluid entering the sprinkler is air or a mixture of water and air.

U.S. Pat. No. 5,375,768 of Edwin J Hunter discloses a sprinkler including a multiple range variable speed turbine. A throttling device controllably directs a first portion of water to the turbine, and a pressure responsive valve controllably diverts a second portion of the water around the turbine in proportion to the pressure thereof for maintaining the speed of the turbine substantially constant. Again, this device is not designed to detect air or a mixture of water and air and to perform the diversion if the fluid entering the sprinkler is not substantially entirely water.

### SUMMARY OF THE INVENTION

It is therefore the primary object of the present invention to provide a rotor type sprinkler designed to prevent over-spinning of its turbine when subjected to pressurized air or a mixture of pressurized water and air.

According to the present invention, a sprinkler includes a riser for receiving a pressurized fluid and a nozzle that is mounted at an upper end of the riser for rotation about an axis. A turbine is mounted for rotation inside the riser. A drive mechanism connects the turbine to the nozzle so that rotation of the turbine by the pressurized fluid rotates the nozzle. The sprinkler includes mechanisms for preventing over-spinning of the turbine when the pressurized fluid is air or a mixture of air and water. Damage due to over-spinning of the turbine is thereby avoided. In one version of the sprinkler, the over-spinning prevention mechanism applies a brake force to the turbine. In another version of the sprinkler, the over-spinning prevention mechanism re-directs air or a mixture of water and air around the turbine.

### BRIEF DESCRIPTION OF THE DRAWINGS

FIG. 1 is a fragmentary vertical sectional view of a first embodiment of the present invention.

FIG. 2 is a fragmentary vertical sectional view of a second embodiment of the present invention.

FIG. 3 is a fragmentary vertical sectional view of a third embodiment of the present invention.

FIG. 4 is a fragmentary vertical sectional view of a fourth embodiment of the present invention.

### DESCRIPTION OF THE PREFERRED EMBODIMENT

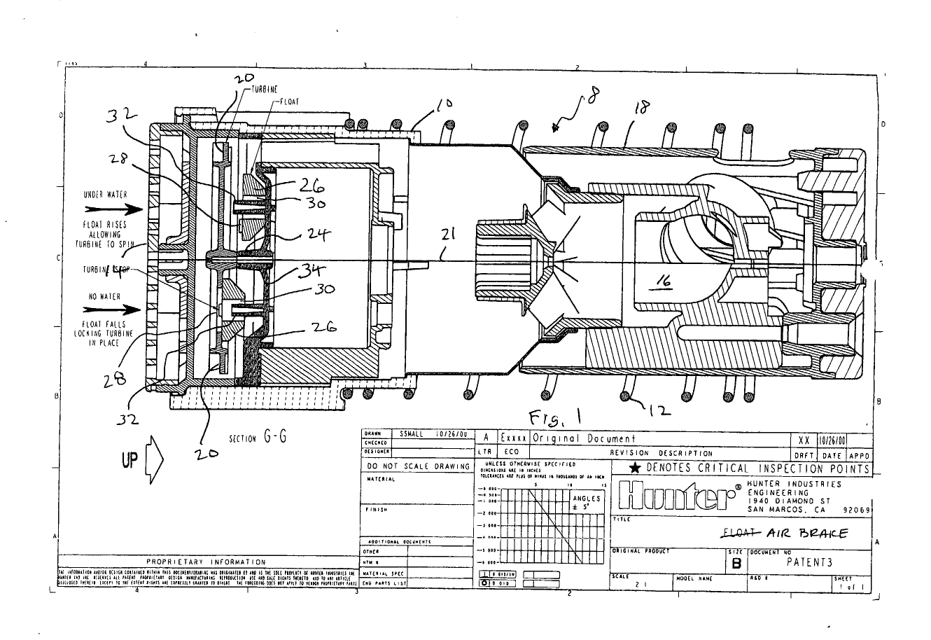

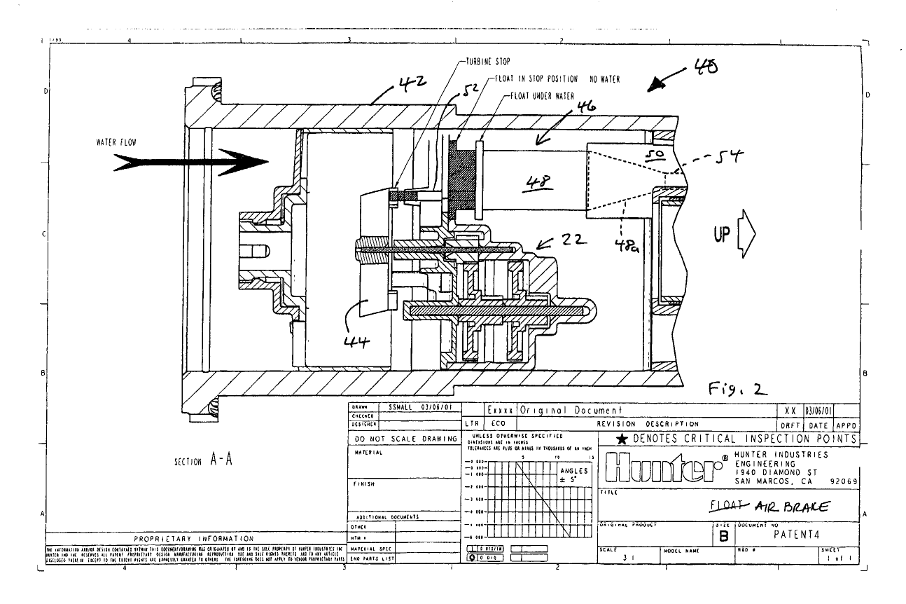

Referring to FIG. 1, according to a first embodiment of the present invention a sprinkler 8 includes an extensible or telescoping tubular hollow riser 10 normally biased to a retracted position within an outer cylindrical housing (not illustrated) by a coil spring 10. The riser 10 has a lower end with a grit screen or filter 14 for receiving therethrough a pressurized fluid, which is usually water, but may also be air or a mixture of water and air. A nozzle 16 is mounted inside a head or turret 18 at an upper end of the riser 10 for rotation about its vertical axis (which extends horizontally in FIG. 1). A turbine 20 is mounted for rotation inside the riser 12. The turbine 20 is multi-bladed and is supported for rotation on a metal shaft (not illustrated) that extends vertically through the center of the turbine 20 coincident with the central vertical axis 21 of the riser 10. A drive mechanism including a gear train reduction such as 22 (FIG. 2) connects the turbine 20 to the nozzle 16 so that rotation of the turbine 20 by the pressurized fluid rotates the nozzle 16 and the head 18. The drive mechanism further includes related nozzle drive components in the form of a reversing mechanism (not illustrated) and an arc adjustment mechanism (not illustrated) so that the user can set the sprinkler 8 to water a given size sector, as is well known in the art. See, for example, U.S. Pat. Nos. 3,107,056; 4,568,024; 4,624,412; 4,718,605; 4,796,809; 4,867,379; and 4,948,052, all of Edwin J. Hunter, the entire disclosures of which are specifically incorporated herein by reference.

The sprinkler 8 of FIG. 1 further includes mechanisms hereafter described for preventing over-spinning of the turbine 20 when the pressurized fluid is air or a mixture of water and air as would occur during winterization or in the Spring when an irrigation system incorporating the sprinkler 8 of FIG. 1 is refilled with water. Damage to the turbine drive shaft, its plastic bearings such as 24 or related nozzle drive components due to over-spinning of the turbine 20 is thereby avoided. As used herein, the term “over-spinning” shall refer to a rotational speed, of the turbine 20 which is sufficiently above its normal range of rotational speed to cause damage compared to when the sprinkler 8 is passing substantially entirely water over its nominal water pressure range during the watering of turf or other landscaping. The over-spinning prevention mechanism includes a brake for selectively engaging the turbine 20. The brake includes an annular float 26 that moves upwardly when the pressurized fluid entering the lower end of the riser 10 is substantially entirely water to disengage stop members 28 from the blades of the turbine 20. The float 26 is formed with three equally spaced apart hollow bores 30 that receive three equally spaced fixed guide posts 32. The guide posts 32 extend downwardly from a transversely extending slotted support member 34.

During normal operation of the sprinkler 8 of FIG. 1, the fluid that passes through the grit screen 14 at the lower end of the riser 10 is substantially entirely water. The term “substantially entirely” is used because this water usually contains tiny air bubbles, salt, chlorine, dissolved minerals, grit and other debris. When rotor type sprinklers are being purged of water with high pressure air the fluid passing through the sprinkler 8 is substantially all air or a mixture of water and air wherein the mixture contains a significant percentage of relatively large air bubbles. When the irrigation system is re-filled in the Spring, the rotor type sprinklers first have large volumes of substantially air passing therethrough, followed by surge conditions in which they have a mixture of water and air passing therethrough, until finally the fluid passing through the rotor type sprinklers is substantially entirely water.

When the fluid entering the riser 10 of the sprinkler 8 (FIG. 1) is substantially entirely water, the buoyancy of the float 26 (FIG. 1) combined with the impact force of the pressurized water is sufficient such that the float 26 will move vertically and the stop members 28 will disengage from the turbine 20. The turbine 20 is thus free to spin at an RPM within its normal range of rotational speed, driving the nozzle 16 back and forth over its pre-set arc. When the pressurized water supply to the lower end of the sprinkler 8 of FIG. 1 is turned OFF, the float 26 descends under the force of gravity. When the fluid passing through the grit screen 14 of the sprinkler 8 of FIG. 1 is air or a mixture of water and air, the float 26 does not move upwardly, and instead it acts as a brake, preventing any turning of the turbine 20. Without this braking force, the turbine 20 would over-spin, damaging the turbine bearing 24, turbine shaft or related nozzle drive components.

Referring to FIG. 2, a second embodiment of the present invention comprises a sprinkler 40 including a tubular riser 42, a turbine 44 connected to the gear train reduction 22, and a single brake 46. The brake 46 is asymmetrically located within the riser 42 and reciprocates up and down above the turbine 44 between the solid line and shaded positions illustrated FIG. 2. The brake 46 includes a cylindrical hollow float 48 that is received inside a cylindrical hollow guide sleeve 50. The brake 46 also includes a single downwardly depending stop member 52 that engages and disengages the blades of turbine 44. The float 48 has a tapered upper end 48a that connects to a vertically extending guide rod 54. When the fluid flowing through the lower end of the riser 42 is substantially entirely water, the float 48 rises upwardly and the turbine 44 is unlocked. The float 48 rises upwardly due in part to its buoyancy and in part due to the force of the pressurized water pushing against the float 48. The turbine 44 remains locked if air or a mixture of water and air flows through the riser 42.

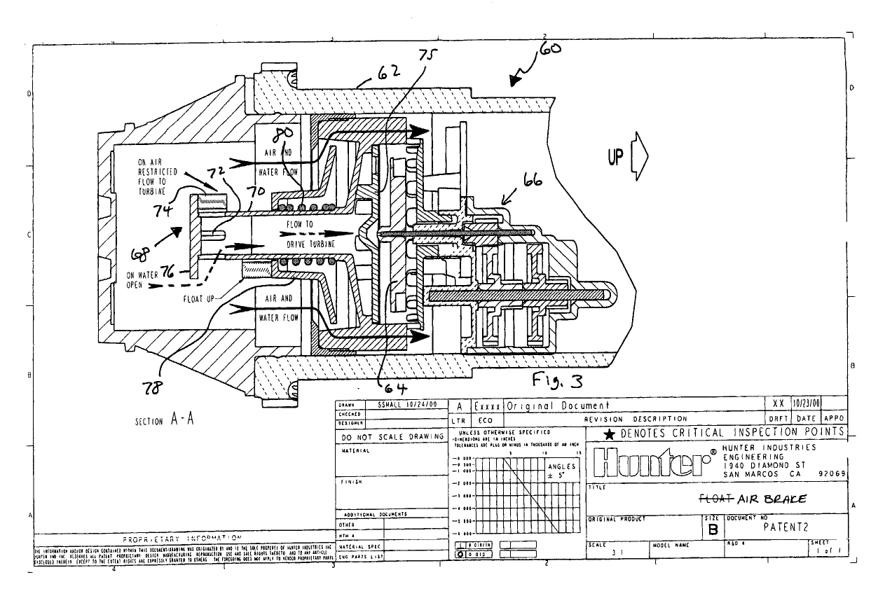

Referring to FIG. 3, a third embodiment of the present invention comprises a sprinkler 60 including a tubular riser 62, a turbine 64 connected to the gear train reduction 66, and a valve 68 for selectively re-directing fluid around the turbine 64 to prevent it from over-spinning. A flow tube 70 directs water to the turbine 64. The lower end of the flow tube 70 is formed with a plurality of circumferentially spaced inlet orifices 72. A cylindrical float 74 surrounds the flow tube 70 and functions as a valve member that closes and seals the inlet orifices 72 unless the fluid entering the lower end of the riser 62 is substantially entirely water, in which case the float moves upwardly to the position shown in phantom lines in FIG. 3. Water then passes through the center of the flow tube 70, and through a slotted transverse member 75, to drive the turbine 64. This flow of water is illustrated by the dashed arrows in FIG. 3.

When air or a mixture of water and air enters the lower end of the riser 62 (FIG. 3), the float 74 remains in its lower position seated on a flange 76 where it completely seals the inlet orifices 72. When the float 74 is in this position, the air or water/air mixture moves a generally funnel shaped valve member 78 that surrounds the tube 70 upwardly, compressing coil spring 80. This allows the air or water/air mixture to pass through the riser 62 around the turbine 64 to prevent over-spinning of the same. The flow of air or a mixture of water and air is illustrated diagrammatically in FIG. 3 by the twin solid arrows.

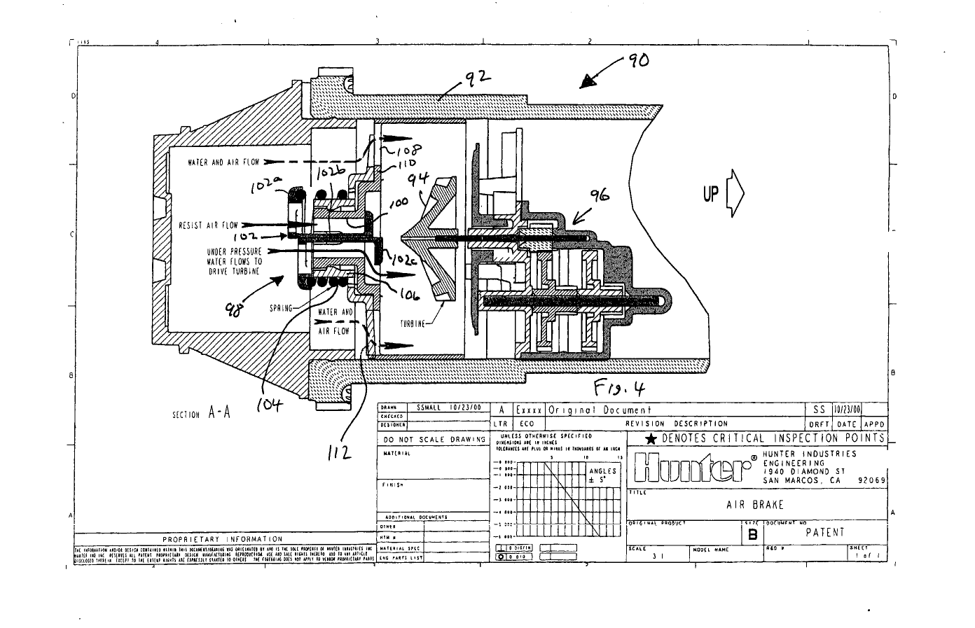

Referring to FIG. 4, a fourth embodiment of the present invention comprises a sprinkler 90 including a tubular riser 92, a turbine 94 connected to the gear train reduction 96, and a valve 98 for selectively re-directing fluid around the turbine 94 to prevent it from over-spinning. A central flow tube 100 directs water to the turbine 94. The lower end of the flow tube 70 is automatically opened and sealed by a valve member 102. The valve member 102 moves between a lower open position and a raised closed position as indicated by the split illustration of the valve member 102 in FIG. 4. The valve member 102 does not actually have this shape, but it has been split down its center axis and its two halves shown in the lower and upper positions to illustrate the range of vertical movement of the valve member 102 within the sprinkler 90.

The valve member 102 (FIG. 4) has a lower annular spring seat 102a connected to a central shaft 102b by radially extending ribs (not visible). A solid disc-shaped seal member 102c is connected to the upper end of the central shaft 102b. When the fluid entering the lower end of the riser 92 is substantially entirely water the force of the water pushing against the solid disc-shaped seal member 102c moves the valve member 102 upwardly to the position shown by the lower half of the valve member 102 closest to the large solid arrow in FIG. 4, compressing a coil spring 104 that encircles a sleeve 106 surrounding the tube 100. The water flows through the flow tube 100 to drive the turbine 104 at an RPM within its normal range of rotational speed. The flow path of the water through the flow tube 100 is illustrated by the twin solid arrows in FIG. 4.

When air or a mixture of water and air enters the lower end of the riser 92 (FIG. 4), the valve member 102 remains in its lower position shown by the upper half of the valve member closest to the shorter solid arrow in FIG. 4. When the valve member is in this lowered position, the solid disc-shaped seal member 102c seals the orifice formed by the central hollow interior of the tube 100. When the valve member 102 is in this lower position, the air or water/air mixture moves around the sleeve 106 between a plurality of radially extending ribs 108 in a support member 110 that supports the tube 100 and sleeve 106. This allows the air or water/air mixture to pass through the riser 92 largely around the turbine 94 to prevent over-spinning of the same. The flow path of the air or water/air mixture is illustrated by the dashed arrows in FIG. 4. An arcuately slotted collar 112 is manually rotatable over the support member 110 to vary the size of the openings between the ribs 108. This adjustable stator sets the speed of the turbine 94 for the expected water pressure of the system.

It is important to note that the over-spinning prevention mechanisms of the sprinklers of FIGS. 1-4 selectively respond to the flow of air or a mixture of water and air. They operate intermittently between different states, i.e. they apply a brake or divert fluid in response to air or a mixture of water and air entering the riser, but they do not apply a brake or divert fluid if the fluid entering the riser is substantially entirely water. Thus our invention is significantly different from the patented rotary sprinkler with viscous damping and the patented rotary sprinkler with a multiple range variable speed turbine (both described in the background section above) which continuously apply a drag or some amount of diversion and do not intermittently apply drag or divert fluid based on the type of fluid flowing through the sprinkler.

Except for the metal shafts of the gear train reduction, the metal coil springs and the metal over-center spring in the reversing mechanism, the components of the sprinklers of FIGS. 1-4 are generally made of injection molded plastic. The nozzle 16 can be formed as a combination nozzle socket and replaceable nozzle. This allows a nozzle with the desired precipitation rate to be installed, as is well known in the art. The sprinklers of FIGS. 1-4 may also be provided with a flow stop valve that can be manually opened and closed by inserting a tool through the top of the head 18. See for example, U.S. Pat. No. 5,762,270 of Kearby et al., the entire disclosure of which is hereby incorporated by reference. The sprinklers of FIGS. 1-4 could also be provided with optional full circle spray pattern capability in which the nozzle 16 would continuously rotate through a fill three hundred and sixty degrees without reversing.

While we have described several embodiments of our rotor type sprinkler with mechanisms for preventing turbine over-spinning, it will be apparent to those skilled in the art that our invention can be modified in both arrangement and detail depending upon the particular design of the rotor type sprinkler. For example, the brakes need not lock the turbine from any motion, but could instead simply apply a drag force. The brake could also be configured to lock or apply a drag force directly to the gear train reduction 22, the nozzle 16, the head 18 or some other related nozzle drive component. Therefore the protection afforded our invention should only be limited in accordance with the scope of the following claims:

What is claimed is:

1. A sprinkler, comprising:
a riser for receiving a pressurized fluid;
a nozzle;
means for mounting the nozzle at an upper end of the riser for rotation about an axis;
a turbine mounted for rotation inside the riser;
drive means for connecting the turbine to the nozzle so that rotation of the turbine by the pressurized fluid will rotate the nozzle; and
means for preventing over-spinning of the turbine when the pressurized fluid is air or a mixture of water and air.

2. The sprinkler of claim 1 wherein the over-spinning prevention means includes a brake for selectively engaging the turbine.

3. The sprinkler of claim 1 wherein the over-spinning prevention means includes a valve for selectively re-directing the fluid around the turbine.

4. The sprinkler of claim 2 wherein the brake includes at least one float that moves upwardly when the pressurized fluid entering the lower end of the riser is substantially entirely water and disengages a stop member from the turbine.

5. The sprinkler of claim 3 wherein the valve includes at least one float that moves upwardly when the pressurized fluid entering the lower end of the riser is substantially entirely water and covers at least one inlet orifice.

6. The sprinkler of claim 3 wherein the valve includes a spring biased valve member that moves upwardly when the pressurized fluid entering the lower end of the riser is substantially entirely water and covers at least one inlet orifice.

7. The sprinkler of claim 2 wherein the brake includes a float that moves upwardly when the pressurized fluid entering the lower end of the riser is substantially entirely water to disengage a stop member from the turbine.

8. The sprinkler of claim 1 wherein the over-spinning prevention means applies a brake force to the turbine.

9. The sprinkler of claim 1 wherein the over-spinning prevention means re-directs a mixture of water and air around the turbine.

10. The sprinkler of claim 2 wherein the brake includes a single cylindrical hollow float that moves upwardly inside a cylindrical guide sleeve when the pressurized fluid entering the lower end of the riser is substantially entirely water and disengages a stop member from the turbine.

11. A sprinkler, comprising:
a riser for receiving a pressurized fluid;
a nozzle mounted at an upper end of the riser for rotation about an axis;
a turbine mounted for rotation inside the riser;
a drive mechanism connecting the turbine to the nozzle so that rotation of the turbine by the pressurized fluid will rotate the nozzle; and
a brake configured and mounted within the riser to selectively engage the turbine to prevent over-spinning of the turbine when the pressurized fluid is air or a mixture of water and air.

12. The sprinkler of claim 11 wherein the brake includes at least one float that moves upwardly when the pressurized fluid entering the lower end of the riser is substantially entirely water and disengages a stop member from the turbine.

13. The sprinkler of claim 11 wherein the brake includes a cylindrical hollow float that moves upwardly when the pressurized fluid entering the lower end of the riser is substantially entirely water to disengage a stop member from the turbine.

14. The sprinkler of claim 1 wherein the brake locks the turbine against rotation.

15. The sprinkler of claim 11 wherein the brake includes a single cylindrical hollow float that moves upwardly inside a cylindrical guide sleeve when the pressurized fluid entering the lower end of the riser is substantially entirely water and disengages a stop member from the turbine.

16. A sprinkler, comprising:
a riser for receiving a pressurized fluid;
a nozzle mounted at an upper end of the riser for rotation about an axis;
a turbine mounted for rotation inside the riser;
a drive mechanism connecting the turbine to the nozzle so that rotation of the turbine by the pressurized fluid will rotate the nozzle; and
a valve configured and mounted in the riser to selectively re-direct the fluid around the turbine if the fluid is air or a mixture of water and air.

17. The sprinkler of claim 16 wherein the valve includes at least one float that moves upwardly when the pressurized fluid entering the lower end of the riser is substantially entirely water and covers at least one inlet orifice.

18. The sprinkler of claim 16 wherein the valve includes a spring biased valve member that moves upwardly when the pressurized fluid entering the lower end of the riser is substantially entirely water and covers at least one inlet orifice.

19. The sprinkler of claim 16 wherein the valve includes a cylindrical float that moves upwardly when the fluid entering the riser is substantially entirely water.

20. The sprinkler of claim 16 wherein the sprinkler further includes a spring biased generally funnel shaped valve member.
